(19) United States
(12) Patent Application Publication
(10) Pub. No.: US 2021/0147767 A1
(43) Pub. Date: May 20, 2021

(54) STAIN REMOVAL

(71) Applicant: The Stain Saint LLC, Minneapolis, MN (US)

(72) Inventor: Patricia Pendleton, Minneapolis, MN (US)

(21) Appl. No.: 16/950,234

(22) Filed: Nov. 17, 2020

Related U.S. Application Data
(60) Provisional application No. 62/937,164, filed on Nov. 18, 2019.

(51) Int. Cl. C11D 11/00; C11D 3/39

(52) U.S. Cl. CPC C11D 11/0017; C11D 3/3932; C11D 3/3942

(57) ABSTRACT

Processes and formulations are disclosed that can allow the removal of stains and odor from articles of cloth and clothing without compromising their integrity. The disclosed formulations and processes can also retard the deterioration of the articles of cloth and clothing arising from exposure to perspiration, deodorants, or other chemical stains. The formulations include hydrogen peroxide and metasilicate ions.

### CROSS-REFERENCE TO RELATED APPLICATION

This application claims the benefit of U.S. Provisional Application Ser. No. 62/937,164, filed on Nov. 18, 2019, titled STAIN REMOVAL; herein incorporated by reference in its entirety.

### FIELD OF THE INVENTION

The present disclosure relates to formulations and processes for the removal of stains from articles of cloth and clothing.

### BACKGROUND OF THE INVENTION

Stains in articles of cloth and clothing can occur from use and wear. Typically, stain formation in such textiles involves surface staining where a staining substance comes in contact with the textiles' surface and becomes trapped within its fibers. Additionally, stains can be absorbed into the porous membranes of articles of cloth and clothing, making stain removal difficult.

Particularly difficult stains to be removed can occur from the contact of perspiration (sweat) or deodorant with clothing, such as shirts or jackets. Typically, this contact can produce yellow stains within the contacting clothing. These yellow stains are particularly undesirable in light-colored or white articles of clothing. The yellow stains often arise in the armpit or neck areas of clothing where a chemical reaction occurs, such as that between urea (present in perspiration) and the clothing material or chemicals (such as soluble aluminum, present in deodorants with antiperspirants). In addition to a yellowish stain in the clothing, this chemical exposure can create an unpleasant odor that is absorbed into and onto the clothing, which is very difficult to remove.

### SUMMARY OF THE INVENTION

The formulations and processes disclosed herein can allow the removal of stains and odor without compromising the integrity of the affected articles of cloth and clothing. The disclosed formulations and processes can also retard the deterioration of these textiles from exposure to perspiration, deodorants, or other chemical stains.

In one aspect, a process for cleaning stains is disclosed that includes providing a cloth article. The process further includes mixing an aqueous solution containing hydrogen peroxide and metasilicate ions in a container. The process further includes applying the aqueous solution containing hydrogen peroxide and metasilicate ions to the cloth article, particularly a stained portion of the cloth article. Optionally, the aqueous solution is rubbed into the cloth article and allowed to remain for at least 5 minutes. In some embodiments, the aqueous solution is allowed to remain in contact with the cloth article for at least 30 minutes, at least 1 hour, or even at least 4 hours. Subsequent to the exposure to the aqueous solution of hydrogen peroxide and metasilicate ion, the cloth article is washed with water and detergent.

In another aspect, a formulation for cleaning stains is disclosed that consists essentially of hydrogen peroxide and metasilicate ions. In some other embodiments, a formula for cleaning stains is disclosed that consists essentially of water, hydrogen peroxide, and metasilicate ions.

The disclosed process and formulations allow the removal of stains and odor from cloth articles without compromising their integrity. In particular, stains in the armpits of articles of clothing resulting from exposure to perspiration can be easily removed. Furthermore, the disclosed processes and formulations can also retard the deterioration of the clothing from exposure to perspiration.

Features and advantages of the invention will be more readily understood from the following detailed description.

### DETAILED DESCRIPTION

The present disclosure relates to formulations and processes for the removal of stains in articles of cloth and clothing. Reference to various embodiments does not limit the scope of the systems and methods disclosed herein. Additionally, any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

This disclosure generally relates to the removal of stains from articles of cloth and clothing, including garments. In some embodiments, this disclosure relates to cleaning the armpit areas of shirts and other garments. The armpit areas of many shirts can become yellowed over time due to deodorants and/or antiperspirants interacting with human perspiration (human sweat). While not being bound by theory, it is likely that the discoloration of the underarm area of a garment can be caused by a chemical reaction that takes place between urea, a component of human sweat, and antiperspirants and/or deodorants. Antiperspirants and/or deodorants can be acidic and can include aluminum salts. It is believed that this combination (human sweat, acid, and aluminum salts) can cause yellow discoloration on many garments—especially in the armpit areas of shirts and other garments. Additionally, the fabric of garments can become hard and can retain an unpleasant odor that cannot be removed with regular washings and laundry detergents.

To make matters worse, garments, such as shirts, can be deemed unwearable in certain social settings or in the workplace due to unsightly and embarrassing discoloration. This discoloration can be embarrassing and emotionally distressing to the person wearing the garment. Clothes that are free of stains can indicate that their wearer is both clean and hygienic.

Armpit stains can be notoriously difficult to remove from the fabric of shirts and other garments. Products claiming to remove such stains currently on the market, such as OXICLEAN Stain Remover (available from Church & Dwight Co., Inc., Ewing, N.J.), have been, at best, only moderately successful at removing such armpit stains. OXICLEAN includes sodium percarbonate, sodium carbonate, hydrogen peroxide, and a surfactant as its main ingredients. Other products that contain hydrogen peroxide and sodium bicarbonate frequently have been utilized in an attempt to remove armpit stains but have been equally unsuccessful at removing such stains.

Other stains which can be removed with the disclosed process and formulations include stains from: mud, grass, blood, marker, lipstick, mascara, foundation makeup, wine, tomato, oil, feces, vomit, pencil, pen, grease, dirt, food, and stains from yellowing with age.

The disclosed process and formulation involve a novel mixture of chemicals that can improve the removal of stains, typically stains in the armpit areas of shirts and other garments, thus lengthening the useful lifetime of such articles of cloth and clothing. The disclosed process includes mixing hydrogen peroxide (H₂O₂) and metasilicate ions (SiO₃⁻²) and applying the mixture of hydrogen peroxide and metasilicate ions to stains on the articles of cloth and clothing. Typically, this process can be useful for cleaning armpit stains using a novel mixture of standard chemicals. This disclosed process can include providing an article of clothing. The clothing can be any article of clothing that directly or indirectly comes into contact with perspiration. Typical articles of clothing can include shirts, particularly undershirts, other undergarments, pajamas, dresses, shifts, or any article of clothing subject to staining. The disclosed process can be useful for articles of clothing made with cotton, silk, down, sweaters, and canvas. Additionally, the use of the disclosed process is contemplated to be used with other fabrics. It is known that the disclosed formulation will dissolve rawhide, so its use on leather or suede should be avoided.

The disclosed process also includes mixing an aqueous solution containing hydrogen peroxide and metasilicate ions in a container. Hydrogen peroxide (H₂O₂) is available as an aqueous solution in many concentrations. Due to its high reactivity (it is a potent oxidizing agent) and its ability to decompose at higher concentrations, usually dilute concentrations can be used with the process described herein. Typically, reagents with up to about 3%, up to about 5%, up to about 10%, up to about 30%, or even up to 50% v/v can be utilized. More typically, a 3% solution of hydrogen peroxide is sufficient for the disclosed process. In some embodiments, a higher concentration of hydrogen peroxide, such as, for example, 34% hydrogen peroxide, works as well as 3% hydrogen peroxide and, in some cases, can work more efficiently. One possible advantage of using 34% hydrogen peroxide instead of 3% hydrogen peroxide is that the volume of the cleaning solution needed is much lower (due to the higher concentration).

The aqueous solution of hydrogen peroxide, as described above, can be mixed with metasilicate ions (SiO₃⁻²), and then the mixed solution can be applied directly to the stained article of clothing. Metasilicate is derived from metasilicic acid (hydrogen metasilicate) and is available as a sodium salt, calcium salt, barium salt, or a salt of any other divalent cationic system. Typically, sodium metasilicate can be obtained in a pentahydrate (Na₂SiO₃*5H₂O) form under the tradename TSP/90 HEAVY DUTY CLEANER, available from Red Devil, Pryor, Okla. Sodium metasilicate pentahydrate is the commonly available form of metasilicate and is readily available at hardware and grocery stores. Other useful forms of sodium metasilicate include sodium metasilicate anhydrous and sodium metasilicate nonahydrate. Additionally, metasilicate ion can be provided from the dissolution of a salt of a monovalent cation such as lithium or other alkaline metal ions. The mixed solution of metasilicate and hydrogen peroxide can be applied to the article of cloth or clothing to be cleaned. In some embodiments, the mixed solution can be, optionally, rubbed into the stained part of the article. The mixed solution can be allowed to stay in contact with the article of cloth or clothing for a period of time of at least 5 minutes, at least 10 minutes, at least 15 minutes, at least 30 minutes, 1 hour, 4 hours, or even longer. Occasionally, stain removal can occur in less than 5 minutes when the mixed solution is in contact with the article of cloth or clothing. It can be advantageous for the mixed solution to be warm. Typically, it is advantageous for the mixed solution to be similar to the temperature used by washing machines. For man-made fibers, such as, for example, knits, and jeans, washing is most efficient between about 30° C. to about 40° C. (86° F. to 104° F.). In some cases, washing can be done at 50° C. (122° F.) or even 60° C. (156° F.). But higher temperatures, although they may enhance cleaning, can also cause physical changes in the articles of clothing being washed, such as, for example, shrinking. The article of cloth or clothing can then be rinsed with water for at least one minute to remove the mixed solution of metasilicate and hydrogen peroxide. Finally, the article of cloth or clothing can be washed with detergent either manually or in an automatic washing machine.

A formulation for cleaning stains from an article of clothing is disclosed that is comprised essentially of hydrogen peroxide and sodium metasilicate. Additionally, a formulation for cleaning stains from an article of clothing is disclosed that is comprised of water, hydrogen peroxide, and sodium metasilicate pentahydrate.

### EXAMPLES

A number of tests were performed on an article of clothing (stained white T-shirt). The following procedure was used for all of the data summarized in the Table below.

### Procedure

A sink was filled with 3 gallons of hot tap water. 0 ounces, 32 fluid ounces, 64 fluid ounces, or 128 fluid ounces hydrogen peroxide (3%) were added to the water along with a variable amount of sodium metasilicate depending upon the test number shown in the Table below. The clothing was immediately added to the sink. It was discovered that the potency of the cleaning solution decreased after time and could not be stored. The contents of the sink were agitated for 15-20 seconds to ensure proper dissolution and mixing of the ingredients. The clothing was allowed to soak for 4 hours. The article of clothing was then removed and washed with detergent in a single wash/rinse cycle of a washing machine. The article of clothing was then removed from the washing machine, then machine dried.

After drying, a visual analysis was performed, with the following results noted.

1—clean white article

2—very slight yellowing

3—partial yellowing

4—significant yellowing

### Results

The procedure described above was used on soiled white T-shirts. They all were treated according to the described procedure and then were visually inspected. The results are shown in the Table below.

TABLE
Experimental Results of Stain Removal

| | Metasilicate | Amount | Amount of | Visual |
|---|---|---|---|---|
| | Compound | Metasilicate | 3% H₂O₂ | Analysis |
| Example | Na₂SiO₃•5H₂O | (cups) | (fl. oz.) | Rating |
| Control | Red Devil | 0.75 | 0 | 3 |
| | TSP/90 | | | |
| 1 | Red Devil | 0.75 | 64 | 1 |
| | TSP/90 | | | |
| 2 | Red Devil | 0.75 | 128 | 1 (shirt was |
| | TSP/90 | | | starchy) |
| 3 | Red Devil | 0.50 | 64 | 1.25 (average |
| | TSP/90 | | | of 4 samples) |
| 4 | Red Devil | 0.75 | 64 | 1 (average of |
| | TSP/90 | | | 4 samples) |
| 5 | Red Devil | 1.00 | 64 | 1 (average of |
| | TSP/90 | | | 4 samples) |
| 6 | Red Devil | 2.00 | 64 | 1 (average of |
| | TSP/90 | | | 4 samples) |
| 7 | Sodium Metasilicate | 0.75 | 64 | 2.08 (average |
| | Pentahydrate 99% | | | of 12 samples) |
| 8 | Sodium Metasilicate | 1.0 | 64 | 1.0 (average |
| | Pentahydrate 99% | | | of 2 samples) |
| 9 | Sodium Metasilicate | 2.0 | 64 | 1.0 (average |
| | Pentahydrate 99% | | | of 3 samples) |
| 10 | Sodium Metasilicate | 0.75 | 32 | 1.0 (average |
| | Pentahydrate 99% | | | of 3 samples) |
| 11 | Sodium Metasilicate | 1.0 | 32 | 1.0 (average |
| | Pentahydrate 99% | | | of 3 samples) |
| 12 | Sodium Metasilicate | 2.0 | 32 | 1.0 (average |
| | Pentahydrate 99% | | | of 3 samples) |

Note:
Two different suppliers (lots) of sodium metasilicate pentahydrate 99% were used in the above samples with no significant difference in results due to the different lots.

These results show the difference between two suppliers' lots of sodium metasilicate pentahydrate. Demonstrated above are the varying efficacies of the two lots; for instance, in examples 4 and 7, the same amount of metasilicate was used, but the results were less favorable for the second supplier's lot.

In an additional example, 30% hydrogen peroxide was used instead of 3% hydrogen peroxide with an adjustment in the volume of solution used so that the amount of hydrogen peroxide was the same. Shirts washed with 30% hydrogen peroxide also cleaned very well.

While embodiments of the invention have been illustrated and described, it will also be apparent that various modifications can be made without departing from the scope of the invention. It is also contemplated that various combinations or sub-combinations of the specific features and aspects of the disclosed embodiments can be combined with, or substituted for, one another in order to form varying modes of the invention. Accordingly, it is not intended that the invention be limited, except as by the appended claims.

What is claimed is:

1. A process for cleaning stains comprising:
providing an article of cloth;
mixing an aqueous solution containing hydrogen peroxide and metasilicate ions;
applying the aqueous solution to the article of cloth;
optionally, rubbing the aqueous solution into the article of cloth;
allowing the aqueous solution to remain in contact with the article of cloth for a predetermined period of time; and
washing the article of cloth with detergent.

2. A process for cleaning stains according to claim 1, wherein the aqueous solution is maintained at a temperature between about 30° C. to about 40° C.

3. A process for cleaning stains according to claim 1, wherein the article of cloth comprises a garment having direct exposure to human perspiration.

4. A process for cleaning stains according to claim 3, wherein the garment comprises a shirt or a dress.

5. A process for cleaning stains according to claim 1, wherein the metasilicate ions result from the dissolution of sodium metasilicate pentahydrate.

6. A process for cleaning stains according to claim 1, wherein the hydrogen peroxide is added as a 3% v/v aqueous solution.

7. A process for cleaning stains according to claim 1, wherein the predetermined period of time for the article of cloth to remain in contact with the aqueous solution is at least 5 minutes.

8. A process for cleaning stains according to claim 1, wherein the predetermined period of time for the article of cloth to remain in contact with the aqueous solution is at least 30 minutes.

9. A process for cleaning stains according to claim 1, wherein the predetermined period of time for the article of cloth to remain in contact with the aqueous solution is at least 1 hour.

10. A process for cleaning stains according to claim 1, wherein the predetermined period of time for the article of cloth to remain in contact with the aqueous solution is at least 4 hours.

11. A formulation for cleaning stains from an article of cloth consisting essentially of:
hydrogen peroxide; and
metasilicate ions.

12. A formulation according to claim 11, wherein the formulation is maintained at a temperature between about 30° C. to about 40° C.

13. A formulation according to claim 11, wherein the formulation is maintained at a temperature between about 50° C. to about 60° C.

14. A formulation for cleaning stains from an article of cloth consisting of:
water;
hydrogen peroxide; and
metasilicate ions.

15. A formulation according to claim 14, wherein the formulation is maintained at a temperature between about 30° C. to about 40° C.

16. A formulation according to claim 14, wherein the formulation is maintained at a temperature between about 50° C. to about 60° C.
